(19) United States
(12) Patent Application Publication
(10) Pub. No.: US 2017/0359294 A1
(43) Pub. Date: Dec. 14, 2017

(54) World Wonders Learning is and Educational Initiative, Curriculum, Program, Publishing Resource etc. for Reinventing Schools

(71) Applicant: Daphne Jean Moore, Chicago, IL (US)

(72) Inventor: Daphne Jean Moore, Chicago, IL (US)

(21) Appl. No.: 15/179,973

(22) Filed: Jun. 11, 2016

(51) Int. Cl. H04L 12/58; H04L 29/08; G06Q 50/20

(52) U.S. Cl. CPC H04L 51/32; H04L 51/04; H04L 67/10; H04L 67/02; G06Q 50/20

(57) ABSTRACT

The purpose of D-Elite.net online social media, social network, social gaming and social messaging service website is to connect, communicate, and collaborate socially, as well as send regular or live communication messages, and or mail through their iOffice spot address. D-Elite.net iOffice members could conduct personal and or professional business or maybe startup a new business and use your iOffice spot's communication and messaging system as its home-based communication tool. If you in to games or gaming, members can play a video game or even send a message from your iOffice spot.

### CROSS-REFERENCE TO RELATED APPLICATIONS

The original nonprovisional utility patent application data sheet 37 CFR §1.76 was filed via USPS mail on was on Oct. 14, 2016

### STATEMENT REGARDING FEDERALLY SPONSORED RESEARCH OR DEVELOPMENT (IF APPLICABLE)

None

### BRIEF SUMMARY OF THE INVENTION (PATENT) AND OR BUSINESS METHOD

D-Elite.net iOffice spot is an American internet and intranet online social media, social gaming, social network and social messaging and or a mobile service website. On this social messaging website each of the registered members can send regular and or live communication, messaging and mail through their very own iOffice. In this common spot or posting area all of its members would upload a VIDEO, SHARE, POST, and VIEW information, innovative practices, lessons, strategies and techniques, or creative approaches for businesses, education, and the community. What sets D-Elite.net iOffice spots or iOffice mail apart from regular emailing, texting, an iphone and or any other messaging system is that it was designed to transmit any form of communication that could be conducted out of a regular office.

### DETAILED DESCRIPTION OF THE INVENTION

D-Elite.net iOffice is one of this newest and latest social media, social networking, social gaming and social messaging website. On D-Elite.net all members could connect, communicate, and collaborate in the main social communication center or office lobby. One of the special features on this social media, social gaming and networking website is the registered members and or lease holders could send and or receive regular or live communication and messages from their very own personal. iOffice could even be used as a home-base office tool.

This modern day internet and intranet social media, social gaming, social networking and its communication, messaging and mailing system is created and designed to function as a FREE and or for PAY website. All of D-Elite.net iOffice members must register to become a member. All of the members must complete an iOffice leasing profile containing personal and professional information, as well as create a personalized iOffice mail name and or address. Each of the members can POST their personal and or professional profile cards on D-Elite's iOffice idirectory. Every member may create or select a web designed hosting page for their private iOffice spot. After the D-Elite iOffice host page is complete, members are ready to open up their own private D-Elite iOffice spot and start sending and receiving regular or live online messages, or just simply network or play a game on your lunch break with another member.

### Marketing and Targeted Members

D-Elite.net iOffice is a social media, social gaming, social networking and social gaming website.
It is the latest and hottest trend for social networking sites
You can send a friend a message challenging him to an online game on your lunch break
Get your D-Elite iOffice Spot and get your very own professional communication spot and or tool for your business
You may even submit payment transactions through your D-Elite iOffice spot
Online Specialist, Global Scholars, Tutors, Teachers, and Administrator, entrepreneurs may use their iOffice spot for communicating with clients or parents and students
You can Connect, Communicate, and Collaborate with other members from your personal iOffice on D-Elite.net
A private and public businesses could possibly even set up an interoffice iOffice spot communication account for their employees
Use an iOffice spot versus a Walkie-Talkie for security or police personnel
Professional Presenters can get an iOffice spot and Post a Seminar, Workshop, or Professional Development course or class using your professional forum page, video and or a vehicle similar to skype and or Web Cam
Post your personal and or business profile card on the iOffice Pad Directory
A great space and communication tool for Start-Up Businesses or for Online Specialists
Teacher and student get iOffice spots versus Classroom Website

1. World Wonders Publishing is an innovative approach for publishing educational textbooks, periodicals and well as other publication, both on and offline. This nationwide school district publishing and local and nation clearinghouse system is designed to attract more educators and professional into the field of publication, provide a gateway whereas educators could share educational information worldwide, and simply generate revenue for schools, school districts, city, states, and countries across the nation.
